(19) United States
(12) Patent Application Publication
(10) Pub. No.: US 2020/0067134 A1
(43) Pub. Date: Feb. 27, 2020

(54) MEMBER FOR POWER STORAGE DEVICE, AND POWER STORAGE DEVICE

(71) Applicant: NIPPON ELECTRIC GLASS CO., LTD., Otsu-shi, Shiga (JP)

(72) Inventor: Hideo YAMAUCHI, Otsu-shi (JP)

(21) Appl. No.: 16/492,962

(22) PCT Filed: Apr. 23, 2018
(86) PCT No.: PCT/JP2018/016393

§ 371 Date: Sep. 11, 2019

(30) Foreign Application Priority Data
May 8, 2017 (JP) 2017-092311

(51) Int. Cl. H01M 10/0562; H01M 10/054; H01M 4/38

(52) U.S. Cl. CPC H01M 10/0562; H01M 10/054; H01M 2004/027; H01M 2300/0074; H01M 4/38

(57) ABSTRACT

Provided are a member for a power storage device that can provide a power storage device having a high charge/discharge capacity and excellent charge-discharge cycle characteristics, and the power storage device. A member 1 for a power storage device according to the present invention includes: a solid electrolyte 2 made of a sodium ion-conductive oxide; and a negative electrode layer 3 made of a metal or alloy capable of absorbing and releasing sodium and provided on the solid electrolyte 2.

### TECHNICAL FIELD

The present invention relates to members for power storage devices that can be used in power storage devices, such as all-solid-state sodium-ion secondary batteries, and power storage devices.

### BACKGROUND ART

Hard carbon is proposed as a negative-electrode active material for a sodium-ion secondary battery (Patent Literature 1). However, hard carbon has not only a capacity as low as 200 mAh/g but also a charge/discharge voltage near to 0 V (vs. Na/Na⁺) and, therefore, has a problem that Na-metal dendrites are likely to precipitate on the negative electrode, which is highly risky.

To cope with this, a material made of an oxide, such as SnO, has been considered as a negative-electrode active material for a sodium-ion secondary battery (Patent Literature 2).

### CITATION LIST

### Patent Literature

### [PTL 1]

### JP-A-2009-266821

### [PTL 2]

### JP-A-2015-28922

### SUMMARY OF INVENTION

### Technical Problem

However, with the use of a material made of an oxide, such as SnO, as a negative-electrode active material, upon absorption of Na ions and electrons from a counter electrode during first charge, the electrons are consumed in a conversion reaction for reducing an oxide to a metal, which presents a problem of poor first charge/discharge efficiency.

Unlike the above, metals exemplified by Sn and Bi can absorb Na by forming an alloy with Na and are, therefore, expected to provide a high capacity. However, these metals significantly change in volume owing to absorption/release of Na ions, so that the negative-electrode active material may peel off from a current collector or the negative-electrode active material itself may crack to form a fine powder and the fine powder may be dispersed into an electrolytic solution. Thus, there arises a problem that good charge-discharge cycle characteristics cannot be obtained.

An object of the present invention is to provide a member for a power storage device that can provide a power storage device having a high charge/discharge capacity and excellent charge-discharge cycle characteristics and provide the power storage device.

### Solution to Problem

A member for a power storage device according to the present invention includes: a solid electrolyte made of a sodium ion-conductive oxide; and a negative electrode layer made of a metal or alloy capable of absorbing and releasing sodium and provided on the solid electrolyte.

The metal or alloy preferably contains at least one element selected from the group consisting of Sn, Bi, Sb, and Pb.

The negative electrode layer is preferably formed of a metal film or alloy film formed on the solid electrolyte.

The solid electrolyte is preferably β-alumina, β″-alumina or NASICON crystals.

A power storage device according to the present invention includes the above-described member for a power storage device according to the present invention and a positive electrode layer.

Alternatively, a power storage device according to the present invention may be a power storage device that includes: a solid electrolyte made of a sodium ion-conductive oxide; a negative electrode layer made of a metal or alloy capable of absorbing and releasing sodium; and a positive electrode layer. In this case, the negative electrode layer is preferably formed of a metal film or an alloy film.

### Advantageous Effects of Invention

The present invention can provide a power storage device having a high charge/discharge capacity and excellent charge-discharge cycle characteristics.

### BRIEF DESCRIPTION OF DRAWINGS

FIG. 1 is a schematic cross-sectional view showing a member for a power storage device according to an embodiment of the present invention.

FIG. 2 is a schematic cross-sectional view showing a power storage device according to an embodiment of the present invention.

FIG. 3 is a graph showing first charge and first discharge curves of an evaluation cell in Example 1.

FIG. 4 is a graph showing first charge and first discharge curves of an evaluation cell in Example 3.

FIG. 5 is a graph showing first charge and first discharge curves of an evaluation cell in Example 5.

### DESCRIPTION OF EMBODIMENTS

Hereinafter, a description will be given of preferred embodiments. However, the following embodiments are merely illustrative and the present invention is not intended to be limited to the following embodiments. Throughout the drawings, members having substantially the same functions may be referred to by the same reference characters.

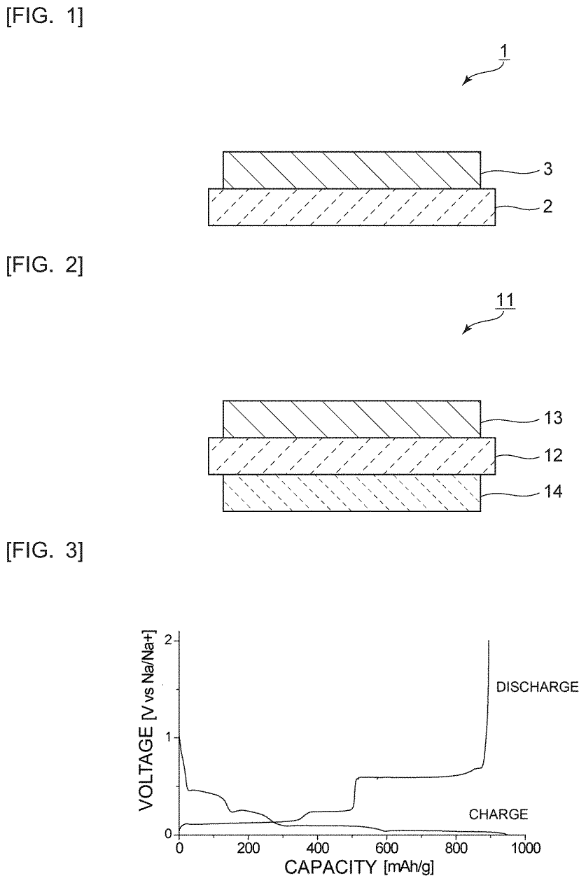

FIG. 1 is a schematic cross-sectional view showing a member for a power storage device according to an embodiment of the present invention. As shown in FIG. 1, a member 1 for a power storage device according to this embodiment includes a solid electrolyte 2 and a negative electrode layer 3 provided on the solid electrolyte 2. The solid electrolyte 2 is made of a sodium ion-conductive oxide. The negative electrode layer 3 is made of a metal or alloy capable of absorbing and releasing sodium. As described previously, when in a battery using a liquid-based electrolyte a negative-electrode active material made of a metal or an alloy is used, there may arise a problem that the negative-electrode active material peels off from a current collector during charge and discharge or a problem that the negative-electrode active material itself cracks to forma fine powder and the fine powder is dispersed into the electrolytic solution. Unlike this, in the member 1 for a power storage device according to this embodiment, since the negative electrode layer 3 is provided on the solid electrolyte 2, the above problems are less likely to arise.

Examples of the metal or alloy capable of absorbing and releasing sodium include metals or alloys that absorb sodium by forming an alloy with sodium. Examples of such metals or alloys include metals or alloys that contain at least one element selected from the group consisting of Sn, Bi, Sb, and Pb. When the negative electrode layer 3 is made of an alloy, it may contain a metal not forming an alloy with sodium. Examples of the metal not forming an alloy with sodium include Zn, Cu, Ni, Co, Si, Al, Mg, and Mo. When the negative electrode layer 3 contains a metal not forming an alloy with sodium, expansion and contraction of the active material during absorption and release of sodium can be suppressed, so that the charge-discharge cycle characteristics can be improved. Particularly, an alloy containing Zn, Cu or Al is preferred because of its ease of processing. The content of the metal not forming an alloy with sodium is preferably in a range of 0 to 80% by mole, more preferably in a range of 10 to 70% by mole, and still more preferably in a range of 35 to 55% by mole. If the content of the metal not forming an alloy with sodium is too large, the charge/discharge capacity may become excessively low.

In this embodiment, from the viewpoint of allowing the negative electrode layer 3 to adhere to the solid electrolyte 2, the negative electrode layer 3 is preferably formed of a metal film or an alloy film. When the adhesion between the negative electrode layer 3 and the solid electrolyte 2 is increased, the charge-discharge cycle characteristics can be further increased. In addition, when the negative electrode layer 3 is formed of a metal film or an alloy film, the negative electrode layer 3 can be densified. Thus, not only the thickness of the negative electrode layer 3 can be reduced, but also the electrically conductive network of the film in an in-plane direction thereof can be widened, so that the electronic resistance of the negative electrode layer 3 can be reduced. As a result, an excellent rate characteristic is provided. Examples of a method for forming the metal film or the alloy film include: physical vapor deposition methods, such as evaporation coating and sputtering; and chemical vapor deposition methods, such as thermal CVD, MOCVD, and plasma CVD. Alternatively, other methods for forming the metal film or the alloy film include liquid phase deposition methods, such as plating, the sol-gel method, and spin coating.

When the metal or alloy is in particulate form, the negative electrode layer 3 may be formed by applying a paste containing metal particles or alloy particles to the surface of the solid electrolyte 2. In this case, if necessary, the applied paste may be thermally treated to form it into a film. Alternatively, the negative electrode layer 3 may be formed by depositing the metal particles or alloy particles on the surface of the solid electrolyte 2 by aerosol deposition, electrostatic powder coating or other processes. In this case, it is preferred to apply pressure to the deposited metal particles or alloy particles to densify them, thus improving the electrical conductivity or the ionic conductivity. Alternatively, the deposited metal particles or alloy particles may be heated to near their melting point to densify them, thus improving the electrical conductivity or the ionic conductivity.

The negative electrode layer 3 may contain a solid electrolyte powder, a conductive aid such as carbon, a binder, and so on. When the negative electrode layer 3 contains the solid electrolyte powder, the contact interface between the active material and the solid electrolyte powder increases to facilitate the absorption and release of sodium ions during charge and discharge, so that the rate characteristic can be improved. The solid electrolyte powder that can be used is a powder of the same material as used for the solid electrolyte 2 to be described hereinafter. The average particle diameter of the solid electrolyte powder is preferably 0.01 to 15 μm, more preferably 0.05 to 10 μm, and particularly preferably 0.1 to 5 μm. If the average particle diameter of the solid electrolyte powder is too large, the distance taken to conduct sodium ions becomes long, so that the ionic conductivity tends to decrease. In addition, the ion-conducting path between the active material powder and the solid electrolyte powder tends to reduce. As a result, the discharge capacity is likely to decrease. On the other hand, if the average particle diameter of the solid electrolyte powder is too small, degradation due to elution of sodium ions and reaction thereof with carbon dioxide may occur, so that the ionic conductivity is likely to decrease. In addition, voids are likely to be formed, so that the electrode density is likely to decrease. As a result, the discharge capacity tends to decrease.

The preferred binder is propylene carbonate (PPC), which is capable of decomposing at low temperatures under an inert atmosphere. Alternatively, carboxymethyl cellulose (CMC), which has an excellent ionic conductivity, is also preferred.

The thickness of the negative electrode layer 3 is preferably in a range of 0.05 to 50 μm and still more preferably in a range of 0.3 to 3 μm. If the thickness of the negative electrode layer 3 is too small, the absolute capacity (mAh) of the negative electrode decreases, which is not preferred. If the thickness of the negative electrode layer 3 is too large, the resistance becomes large, so that the capacity (mAh/g) tends to decrease.

The amount of the negative electrode 3 deposited on the solid electrolyte 2 is preferably in a range of 0.01 to 5 (mg/cm²) and more preferably in a range of 0.4 to 0.9 (mg/cm²). If the amount of the negative electrode layer 3 deposited is too small, the absolute capacity (mAh) of the negative electrode decreases, which is not preferred. If the amount of the negative electrode layer 3 deposited is too large, the resistance increases, so that the capacity (mAh/g) tends to decrease.

In this embodiment, the solid electrolyte 2 is made of a sodium ion-conductive oxide. Examples of the sodium ion-conductive oxide include compounds containing: at least one selected from the group consisting of Al, Y, Zr, Si, and P; Na; and O, and specific examples thereof include β-alumina, β″-alumina, and NASICON crystals. These materials are preferably used because they have excellent sodium-ion conductivity.

Examples of an oxide material containing β-alumina or β″-alumina include those containing, in terms of % by mole, 65 to 98% Al₂O₃, 2 to 20% Na₂O, and 0.3 to 15% MgO+Li₂O. Reasons why the composition is limited as above will be described below. Note that in the following description “%” refers to “% by mole” unless otherwise stated. Furthermore, “(component)+(component)+ . . . ” means the total sum of the contents of the relevant components.

Al₂O₃ is a main component of β-alumina or β″-alumina. The content of Al₂O₃ is preferably 65 to 98% and particularly preferably 70 to 95%. If Al₂O₃ is too little, the ionic conductivity is likely to decrease. On the other hand, if Al₂O₃ is too much, α-alumina, which has no ionic conductivity, remains, so that the ionic conductivity is likely to decrease.

Na₂O is a component that gives sodium-ion conductivity to the solid electrolyte. The content of Na₂O is preferably 2 to 20%, more preferably 3 to 18%, and particularly preferably 4 to 16%. If Na₂O is too little, the above effect is less likely to be achieved. On the other hand, if Na₂O is too much, surplus sodium forms compounds not contributing to ionic conductivity, such as NaAlO₂, so that the ionic conductivity is likely to decrease.

MgO and Li₂O are components (stabilizers) that stabilize the structures of β-alumina and β″-alumina. The content of MgO+Li₂O is preferably 0.3 to 15%, more preferably 0.5 to 10%, and particularly preferably 0.8 to 8%. If MgO+Li₂O is too little, α-alumina remains in the solid electrolyte, so that the ionic conductivity is likely to decrease. On the other hand, if MgO+Li₂O is too much, MgO or Li₂O having failed to function as a stabilizer remains in the solid electrolyte, so that the ionic conductivity is likely to decrease.

The solid electrolyte preferably contains, in addition to the above components, ZrO₂ and Y₂O₃. ZrO₂ and Y₂O₃ have the effect of suppressing abnormal grain growth of β-alumina and/or β″-alumina during firing of raw materials to produce a solid electrolyte and thus increasing the adhesion of particles of β-alumina and/or β″-alumina. The content of ZrO₂ is preferably 0 to 15%, more preferably 1 to 13%, and particularly preferably 2 to 10%, while the content of Y₂O₃ is preferably 0 to 5%, more preferably 0.01 to 4%, and particularly preferably 0.02 to 3%. If ZrO₂ or Y₂O₃ is too much, the amount of β-alumina and/or β″-alumina produced decreases, so that the ionic conductivity is likely to decrease.

Examples of the NASICON crystals include those containing crystals represented by a general formula NasA1tA2uOv (where A1 is at least one selected from the group consisting of Al, Y, Yb, Nd, Nb, Ti, Hf, and Zr, A2 is at least one selected from Si and P, s=1.4 to 5.2, t=1 to 2.9, u=2.8 to 4.1, and v=9 to 14). In preferred embodiments of the above crystals, Al is at least one from among Y, Nb, Ti, and Zr, s=2.5 to 3.5, t=1 to 2.5, u=2.8 to 4, and v=9.5 to 12. By doing so, crystals having excellent ionic conductivity can be obtained. Particularly, monoclinic or trigonal NASICON crystals are preferred because they have excellent ionic conductivity.

Specific examples of the crystal represented by the above general formula NasA1tA2uOv include Na₃Zr₂Si₂PO₁₂, Na_{3.2}Zr_{1.3}Si_{2.2}P_{0.8}O_{10.5}, Na₃Zr_{1.6}TiO_{0.4}Si₂PO₁₂, Na₃Hf₂Si₂PO₁₂, Na_{3.4}Zr_{0.9}Hf_{1.4}Al_{0.6}Si_{1.2}P_{1.8}O₁₂, Na₃Zr_{1.7}Nb_{0.24}Si₂PO₁₂, Na_{3.6}Ti_{0.2}Y_{0.8}Si_{2.8}O₉, Na₃Zr_{1.88}Y_{0.12}Si₂PO₁₂, Na_{3.12}Zr_{1.88}Y_{0.12}Si₂PO₁₂, and Na_{3.6}Zr_{0.13}Yb_{1.67}Si_{0.11}P_{2.9}O₁₂.

The thickness of the solid electrolyte 2 is preferably in a range of 10 to 2000 μm and more preferably in a range of 50 to 200 μm. If the thickness of the solid electrolyte 2 is too small, this decreases the mechanical strength and is thus liable to bring about breakage, so that an internal short-circuit is likely to develop. If the thickness of the solid electrolyte 2 is too large, the distance of ion conduction accompanying charge and discharge becomes long and the internal resistance therefore becomes high, so that the discharge capacity and the operating voltage are likely to decrease. In addition, the energy density of the power storage device per unit volume tends to decrease.

The solid electrolyte 2 can be produced by mixing raw material powders, forming the mixed raw material powders into a shape, and then firing them. For example, the solid electrolyte 2 can be produced by making the raw material powders into a slurry, forming a green sheet from the slurry, and then firing the green sheet. Alternatively, the solid electrolyte 2 may be produced by the sol-gel method.

In this embodiment, since the negative electrode layer 3 is made of a metal or alloy capable of absorbing and releasing sodium, it has a high charge/discharge capacity. Furthermore, since the negative electrode layer 3 is provided on the solid electrolyte 2, it exhibits good charge-discharge cycle characteristics. When the negative electrode layer 3 is formed as a metal film or an alloy film on the solid electrolyte 2 and deposited on the solid electrolyte 2, it exhibits better charge-discharge cycle characteristics.

In this embodiment, the negative electrode layer 3 can also function as a negative electrode current collector. Therefore, there are cases where a negative electrode current collector that would be necessary for conventional power storage devices is not necessary.

FIG. 2 is a schematic cross-sectional view showing a power storage device according to an embodiment of the present invention. As shown in FIG. 2, a power storage device 11 according to this embodiment includes: a solid electrolyte 12 made of a sodium ion-conductive oxide; a negative electrode layer 13 made of a metal or alloy capable of absorbing and releasing sodium; and a positive electrode layer 14. The power storage device 11 according to this embodiment can be used as an all-solid-state sodium-ion secondary battery. In this embodiment, the member 1 for a power storage device shown in FIG. 1 is used as the solid electrolyte 12 and the negative electrode layer 13. Therefore, the negative electrode layer 13 is preferably formed as a metal film or an alloy film on the solid electrolyte 2 and deposited on the solid electrolyte 12. However, the power storage device according to the present invention is not limited to this.

The solid electrolyte 12 and the negative electrode layer 13 that can be used in this embodiment are the same as the solid electrolyte 2 and the negative electrode layer 3 used in the embodiment shown in FIG. 1.

No particular limitation is placed on the positive electrode layer 14 to be used in this embodiment so long as it contains a positive-electrode active material capable of absorbing and releasing sodium and functions as a positive electrode layer. For example, the positive electrode layer 14 may be formed by firing an active material precursor powder, such as a glass powder. When the active material precursor powder is fired, the active material crystals precipitate and these active material crystals function as a positive-electrode active material.

Examples of the active material crystals functioning as a positive-electrode active material include sodium transition metal phosphate crystals containing Na, M (where M represents at least one transition metal element selected from among Cr, Fe, Mn, Co, V, and Ni), P, and O. Specific examples include Na₂FeP₂O₇, NaFePO₄, Na₃V₂ (PO₄)₃, Na₂NiP₂O₂, Na_{3.64}Ni_{2.18}(P₂O₇)₂, and Na₃Ni₃(PO₄)₂ (P₂O₇). These sodium transition metal phosphate crystals are preferred because they have high capacities and excellent chemical stability. Preferred among them are triclinic crystals belonging to space group P1 or P-1 and particularly preferred are crystals represented by a general formula NaxMyP₂Oz (where 1.2≤x≤2.8, 0.95≤y≤1.6, and 6.5≤z≤8), because these crystals have excellent cycle characteristics. Other active material crystals functioning as a positive-electrode active material include layered sodium transition metal oxide crystals, such as NaCrO₂, Na_{0.7}MnO₂, and NaFe_{0.2}Mn_{0.4}Ni_{0.4}O₂.

Examples of the active material precursor powder include those containing (i) at least one transition metal element selected from the group consisting of Cr, Fe, Mn, Co, Ni, Ti, and Nb, (ii) at least one element from among P, Si, and B, and (iii) O.

Examples of the positive-electrode active material precursor powder include those containing, in terms of % by mole of oxide, 8 to 55% Na₂O, 10 to 70% CrO+Fe0+MnO+Co0+NiO, and 15 to 70% P205+SiO₂+B₂O₃. Reasons why each of the components is limited as above will be described below. Note that in the description of the content of each component “%” refers to “% by mole” unless otherwise stated.

Na₂O serves, during charge and discharge, as a supply source of sodium ions that move between the positive-electrode active material and a negative-electrode active material. The content of Na₂O is preferably 8 to 55%, more preferably 15 to 45%, and particularly preferably 25 to 35%. If Na₂O is too little, the amount of sodium ions contributing to the absorption and release becomes small, so that the discharge capacity tends to decrease. On the other hand, if Na₂O is too much, other crystals not contributing to charge and discharge, such as Na₃PO₄, becomes likely to precipitate, so that the discharge capacity tends to decrease.

CrO, FeO, MnO, CoO, and NiO are components that change the valence of each transition element during charge and discharge to cause a redox reaction and thus act as a drive force for absorption and release of sodium ions. Among them, NiO and MnO have a significant effect of increasing the redox potential. Furthermore, FeO is particularly likely to stabilize the structure during charge and discharge and therefore likely to improve the cycle characteristics. The content of CrO+FeO+MnO+CoO+NiO is preferably 10 to 70%, more preferably 15 to 60%, even more preferably 20 to 55%, still more preferably 23 to 50%, yet still more preferably 25 to 40%, and particularly preferably 26 to 36%. If CrO+FeO+MnO+CoO+NiO is too little, the redox reaction accompanying charge and discharge becomes less likely to occur and the amount of sodium ions to be absorbed and released therefore becomes small, so that the discharge capacity tends to decrease. On the other hand, if CrO+FeO+MnO+CoO+NiO is too much, other crystals precipitate, so that the discharge capacity tends to decrease.

P₂O₅, SiO₂, and B₂O₃ each forma three-dimensional network and, therefore, have the effect of stabilizing the structure of the positive-electrode active material. Particularly, P₂O₅ and SiO₂ are preferred because they have excellent ionic conductivity, and P₂O₅ is most preferred. The content of P₂O₅+SiO₂+B₂O₃ is preferably 15 to 70%, more preferably 20 to 60%, and particularly preferably 25 to 45%. If P₂O₅+SiO₂+B₂O₃ is too little, the discharge capacity tends to decrease after repeated charge and discharge. On the other hand, if P₂O₅+SiO₂+B₂O₃ is too much, other crystals not contributing to charge and discharge, such as P₂O₅, tends to precipitate. The content of each of P₂O₅, SiO₂, and B₂O₃ components is preferably 0 to 70%, more preferably 15 to 70%, still more preferably 20 to 60%, and particularly preferably 25 to 45%.

Furthermore, in addition to the above components, various components can be incorporated into the positive-electrode active material as long as not impairing the effects as the positive-electrode active material, so that vitrification can be facilitated. Examples of such components include, in terms of oxides, MgO, CaO, Sr, BaO, ZnO, CuO, Al₂O₃, GeO₂, Nb₂O₅, ZrO₂, V₂O₅, and Sb₂O₅. Particularly, Al₂O₃ acting as a network forming oxide and V₂O₅ serving as an active material component are preferred. The content of the above components is, in total, preferably 0 to 30%, more preferably 0.1 to 20%, and particularly preferably 0.5 to 10%.

The preferred positive-electrode active material precursor powder is one capable of forming an amorphous phase together with positive-electrode active material crystals when subjected to firing. When an amorphous phase is formed, the sodium-ion conductivity through the positive electrode layer 14 and at the interface between the positive electrode layer 14 and the solid electrolyte 12 can be improved.

The average particle diameter of the active material precursor powder is preferably 0.01 to 15 μm, more preferably 0.05 to 12 μm, and particularly preferably 0.1 to 10 μm. If the average particle diameter of the active material precursor powder is too small, the cohesion between the active material precursor powder increases, so that the active material precursor powder tends to be poor in dispersibility when made in paste form. As a result, the internal resistance of the battery becomes high, so that the operating voltage is likely to decrease. In addition, the electrode density decreases, so that the battery capacity per unit volume tends to decrease. On the other hand, if the average particle diameter of the active material precursor powder is too large, sodium ions are less likely to diffuse and the internal resistance tends to be high. In addition, the electrode tends to be poor in surface smoothness.

In the present invention, the average particle diameter means D50 (a volume-based average particle diameter) and refers to a value measured by the laser diffraction/scattering method.

The thickness of the positive electrode layer 14 is preferably in a range of 3 to 300 μm and more preferably in a range of 10 to 150 μm. If the thickness of the positive electrode layer 14 is too small, the capacity of the power storage device 11 itself becomes small, so that the energy density tends to decrease. If the thickness of the positive electrode layer 14 is too large, the resistance to electron conduction becomes large, so that the discharge capacity and the operating voltage tend to decrease.

The positive electrode layer 14 may contain, if necessary, a solid electrolyte powder. The solid electrolyte powder that can be used is the same as the solid electrolyte powder contained in the negative electrode layer 13. When the positive electrode layer 14 contains the solid electrolyte powder, the sodium-ion conductivity in the positive electrode layer 14 and at the interface between the positive electrode layer 14 and the solid electrolyte 12 can be improved.

The volume ratio between the active material precursor powder and the solid electrolyte powder is preferably 20:80 to 95:5, more preferably 30:70 to 90:10, and particularly preferably 35:65 to 88:12.

Furthermore, the positive electrode layer 14 may contain, if necessary, a conductive aid, such as carbon powder. When a conductive aid is contained in the positive electrode layer 14, the internal resistance of the positive electrode layer 14 can be reduced. The conductive aid is preferably contained in a proportion of 0 to 20% by mass in the positive electrode layer 14 and more preferably contained in a proportion of 1 to 10% by mass.

The positive electrode layer 14 can be produced using a slurry containing the active material precursor powder and, if necessary, further containing the solid electrolyte powder and/or the conductive aid in the above proportion. If necessary, a binder, a plasticizer, a solvent, and other additives are added into the slurry. The positive electrode layer 14 can be produced by applying the slurry, drying it, and then firing it. Alternatively, the positive electrode layer 14 may be produced by applying the slurry onto a base material made of PET (polyethylene terephthalate) or other materials, drying the slurry, making a green sheet from the slurry, and then firing the green sheet.

No particular limitation is placed on the method for producing the power storage device 11 shown in FIG. 2. For example, it is possible to form the positive electrode layer 14 on one surface of the solid electrolyte 12 and then form the negative electrode layer 13 on the other surface of the solid electrolyte 12. In this case, the positive electrode layer 14 may be formed by applying a slurry for forming a positive electrode layer onto one surface of the solid electrolyte 12, drying the slurry, and then firing the slurry. Alternatively, the solid electrolyte 12 and the positive electrode layer 14 may be formed concurrently by laying a green sheet for forming a solid electrolyte and a green sheet for forming a positive electrode layer one on top of the other and firing these green sheets.

After the positive electrode layer 14 is formed on one surface of the solid electrolyte 12 in the above manner, the negative electrode layer 13 is formed on the other surface of the solid electrolyte 12 in the same manner as in the embodiment shown in FIG. 1.

Alternatively, it is possible to form the negative electrode layer 13 on one surface of the solid electrolyte 12 and then form the positive electrode layer 14 on the other surface of the solid electrolyte 12. In this case, after the negative electrode layer 13 is formed on one surface of the solid electrolyte 12 in the same manner as in the embodiment shown in FIG. 1, the positive electrode layer 14 is formed on the other surface of the solid electrolyte 12 in the same manner as described above.

Still alternatively, it is possible to make the solid electrolyte 12, the negative electrode layer 13, and the positive electrode layer 14 separately from each other and then combining them to produce a power storage device 11.

### EXAMPLES

Hereinafter, a description will be given of the present invention with reference to its examples, but the present invention is not limited to these examples.

### Examples 1 to 5

<Production of Member for Power Storage Device>

As solid electrolytes, use were made of 12-mm square cut pieces of 1-mm thick β″-alumina (Li₂O-stabilized β″-alumina having a composition formula Na_{1.6}Li_{0.34}Al_{10.66}O₁₇ and manufactured by Ionotec Ltd.).

One surface of each solid electrolyte was covered with a masking having a 10-mm square opening and sputtered with a magnetron sputtering system (JEC-3000FC manufactured by JEOL Ltd.) using a target (manufactured by Furuuchi Chemical Corporation) capable of forming a metal film or alloy film having a composition shown in Table 1. Thus, a negative electrode layer made of a metal film or an alloy film was formed on the one surface of the solid electrolyte. The sputtering was performed by introducing argon (Ar) gas into a vacuum with application of an electric current of 30 mA.

Table 1 shows the amounts of negative electrode layer deposited on the solid electrolytes and the thicknesses of the negative electrode layers.

<Production of Evaluation Cell>

Using the members for power storage devices produced in the above manner, cells for evaluating the negative electrode characteristics were produced in the following manner. In an argon atmosphere of the dew point minus 70° C. or below, a metallic sodium layer serving as a counter electrode was pressure-bonded to the surface of each member for a power storage device opposite to the surface thereof on which the negative electrode layer was formed. The obtained laminate was placed on top of a lower lid of a coin cell and capped with an upper lid of the coil cell to produce a CR2032-type evaluation cell.

<Charge and Discharge Test>

The produced evaluation cells were constant-current charged at 60° C. from an open circuit voltage to 0.001 V and their first charge capacities were determined. Next, the evaluation cells were constant-current discharged from 0.001 V to 2.0 V in Examples 1 and 2 or to 2.5 V in Examples 3 to 5 and their first discharge capacities were determined. The C rate was 0.1 C and the discharge capacity retention after 20 cycles relative to the first discharge capacity was calculated from the 20th cycle discharge capacity. In this charge and discharge test, the charge is an absorption of sodium ions into the negative-electrode active material and the discharge is a release of sodium ions from the negative-electrode active material.

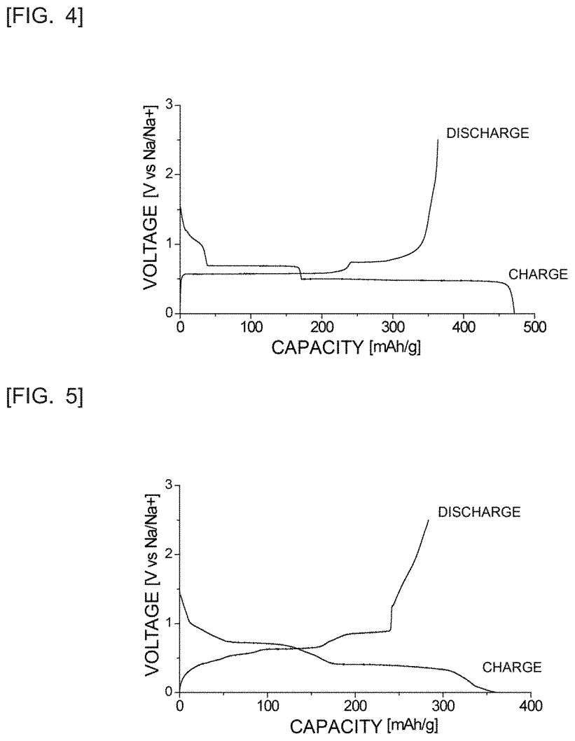

Table 1 shows the first charge capacities, the first discharge capacities, the first charge/discharge efficiencies, and the discharge capacity retentions after 20 cycles. FIGS. 3, 4, and 5 are graphs showing respective first charge and first discharge curves of the evaluation cells in Examples 1, 3, and 5.

TABLE 1

| | | Examples | | | | |
|---|---|---|---|---|---|---|
| | | 1 | 2 | 3 | 4 | 5 |
| Composition | Sn | 100 | 45.5 | — | — | — |
| (% by mole) | Bi | — | — | 100 | 25 | 25 |
| | Cu | — | 54.5 | — | 75 | |
| | Zn | — | — | — | — | 75 |
| | Total | 100 | 100 | 100 | 100 | 100 |
| Negative | Amount of Layer | 0.3 | 0.51 | 0.95 | 0.67 | 0.6 |
| Electrode Layer | Deposited | | | | | |
| | (mg/cm²) | | | | | |
| | Thickness | 407 | 639 | 971 | 714 | 706 |
| | (nm) | | | | | |
| Battery | Charge Capacity | 949 | 553 | 472 | 387 | 361 |
| Characteristics | (mAh/g) | | | | | |
| | Discharge Capacity | 886 | 482 | 364 | 248 | 283 |
| | (mAh/g) | | | | | |
| | First Charge/ | 93.4 | 87.2 | 77.1 | 64.2 | 78.6 |
| | Discharge Efficiency | | | | | |
| | (%) | | | | | |
| | Discharge Capacity | 62 | 67 | 76 | 86 | 88 |
| | Retention | | | | | |
| | (%) | | | | | |

As shown in Table 1, it can be seen that the negative electrodes in Examples 1 to 5 had high charge/discharge capacities and excellent charge-discharge cycle characteristics. Therefore, it can be seen that, with the use of the negative electrodes in Examples 1 to 5, power storage devices having high charge/discharge capacities and excellent charge-discharge cycle characteristics can be obtained.

Furthermore, comparison between Examples 1 and 2 and comparison of Example 3 with Examples 4 and 5 show that when a negative electrode layer contains a metal not forming an alloy with sodium, such as Cu or Zn, the charge-discharge cycle characteristics are improved.

### Comparative Examples 1 and 2

<Production of Negative Electrode>

A 20-μm thick copper foil was used as a negative electrode current collector. One surface of the copper foil was covered with a masking having a 10-mm square opening and sputtered with a magnetron sputtering system (JEC-3000FC manufactured by JEOL Ltd.) using a target (manufactured by Furuuchi Chemical Corporation) capable of forming a metal film having a composition shown in Table 2. Thus, a negative electrode made of a metal film was formed on the one surface of the copper foil. The sputtering was performed by introducing argon (Ar) gas into a vacuum with application of an electric current of 30 mA.

<Production of Evaluation Cell>

Using negative electrodes produced in the above manner, cells for evaluating the negative electrode characteristics were produced in the following manner. Each negative electrode was placed, with its copper foil surface down, on a lower lid of a coin cell, a separator formed of a 16-mm diameter polypropylene porous film dried at 70° C. for eight hours under reduced pressure and a metal sodium layer as a counter electrode were laminated on top of the negative electrode, the electrodes were impregnated with an electrolytic solution, and the laminate was then capped with an upper lid of the coin cell, thus producing an evaluation cell. As the electrolytic solution, a solution was used in which 1M (mole/little) of NaPF₆ was dissolved in a mixed solvent of EC:DEC=1:1. The assembly of the evaluation cell was conducted in an environment of a dew-point temperature minus 70° C. or below.

<Charge and Discharge Test>

The produced evaluation cells underwent a charge and discharge test in the same manner as in Examples 1 to 5 and were thus measured in terms of first charge capacity, first discharge capacity, first charge/discharge efficiency, and discharge capacity retention after 20 cycles. The measurement results are shown in Table 2.

TABLE 2

| | | Comparative Examples | |
|---|---|---|---|
| | | 1 | 2 |
| Composition | Sn | 100 | — |
| (% by mole) | Bi | — | 100 |
| | Cu | — | — |
| | Zn | — | — |
| | Total | 100 | 100 |
| Negative | Amount of Layer | 0.32 | 0.95 |
| Electrode | Deposited (mg/cm²) | | |
| Layer | Thickness (nm) | 434 | 971 |
| Battery | Charge Capacity (mAh/g) | 924 | 458 |
| Characteristics | Discharge Capacity (mAh/g) | 872 | 377 |
| | First Charge/Discharge | 94.4 | 82.3 |
| | Efficiency (%) | | |
| | Discharge Capacity | 0 | 8 |
| | Retention (%) | | |

As shown in Table 2, it can be seen that in Comparative Examples 1 and 2 the first charge/discharge capacities were high, but excellent charge-discharge cycle characteristics could not be obtained.

### REFERENCE SIGNS LIST

1 . . . member for power storage device
2 . . . solid electrolyte
3 . . . negative electrode layer
11 . . . power storage device
12 . . . solid electrolyte
13 . . . negative electrode layer
14 . . . positive electrode layer

1. A member for a power storage device, the member comprising:
a solid electrolyte made of a sodium ion-conductive oxide; and
a negative electrode layer made of a metal or alloy capable of absorbing and releasing sodium and provided on the solid electrolyte.

2. The member for a power storage device according to claim 1, wherein the metal or alloy contains at least one element selected from the group consisting of Sn, Bi, Sb, and Pb.

3. The member for a power storage device according to claim 1, wherein the negative electrode layer is formed of a metal film or alloy film formed on the solid electrolyte.

4. The member for a power storage device according to claim 1, wherein the solid electrolyte is β-alumina, β″-alumina or NASICON crystals.

5. A power storage device comprising:
the member for a power storage device according to claim 1; and
a positive electrode layer.

6. A power storage device comprising:
a solid electrolyte made of a sodium ion-conductive oxide;
a negative electrode layer made of a metal or alloy capable of absorbing and releasing sodium; and
a positive electrode layer.

7. The power storage device according to claim 6, wherein the negative electrode layer is formed of a metal film or an alloy film.
